(19) United States
(12) Patent Application Publication
(10) Pub. No.: US 2010/0188226 A1
(43) Pub. Date: Jul. 29, 2010

(54) DEVICE CONFIGURATION MANAGER AND ABSENT CONNECTION ALERTER

(75) Inventors: THOMAS A. SEDER, Northville, MI (US); Joseph F. Szczerba, Grand Blanc, MI (US); John K. Lenneman, Okemos, MI (US); Shelley Evenson, Pittsburgh, PA (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/362,337

(22) Filed: Jan. 29, 2009

(51) Int. Cl. G08B 13/14

(52) U.S. Cl. 340/572.1

(57) ABSTRACT

A system and method for notifying a vehicle user that a particular item that is part of a predetermined group of items is missing when the user enters the vehicle. Items that a vehicle user may bring into the vehicle that may be part of the group may be in wireless communications with the vehicle by any suitable communications protocol, such as Bluetooth protocol or an RFID tag. The vehicle will identify whether there is a known group of items entering the vehicle, and if so, determine whether an item from that group of items is missing. If a missing item is detected, the vehicle can then notify the user about the missing item. Additionally, the vehicle can also tell the vehicle user where the missing item is located if the missing item is part of an ad-hoc internet group.

### BACKGROUND OF THE INVENTION

1. Field of the Invention

This invention relates generally to a system and method for identifying an item that is not included in a predetermined group of items and providing a signal indicating same and, more particularly, to a system and method employed on a vehicle for identifying when an electronic device, or other device including an RFID tag, is missing from a predetermined group of devices it should be with, and identifying the location of the device.

2. Description of the Related Art

When a person travels to work or other locations, he or she may carry on or about his or her person a number of electronic devices, such as cellular telephones, laptops, cameras, personal data assistants (PDAs), pagers, etc., and non-electronic devices, such as brief cases, keys, coffee cup, etc. Many of these devices are important and necessary to the person when they arrive at the location. Thus, forgetting to bring a particular device may require the person to return to retrieve the device, possibly causing great inconvenience. Thus, a system that notifies a person, such as a vehicle user, that an item that is part of a group of items that may be carried to work or otherwise is missing may be desirable.

### SUMMARY OF THE INVENTION

In accordance with the teachings of the present invention, a system and method are disclosed for notifying a vehicle user that a particular item that is part of a predetermined group of items is missing when the user enters the vehicle. Items that a vehicle user may bring into the vehicle that may be part of the group may be in wireless communications with the vehicle by any suitable communications protocol, such as Bluetooth protocol. An item brought into the vehicle can have an RFID tag and an RFID reader on the vehicle can read the RFID tag to detect the item. The vehicle will identify whether there is a known group of items entering the vehicle, and if so, determine whether an item from that group of items is missing. If a missing item is detected, the vehicle can then notify the user about the missing item. Additionally, the vehicle can also tell the vehicle user where the missing item is located if the missing item is part of an ad-hoc internet group.

Additional features of the present invention will become apparent from the following description and appended claims, taken in conjunction with the accompanying drawings.

### BRIEF DESCRIPTION OF THE DRAWING

FIG. 1 is an illustration of a system that recognizes that a group of items has entered a vehicle, notifies a vehicle user if one of the items is missing from the group and tells the user where the missing item is located.

### DETAILED DESCRIPTION OF THE EMBODIMENTS

The following discussion of the embodiments of the invention directed to a system and method for recognizing that a group of items has entered a vehicle, notifying a vehicle user if an item from the group of items is missing, and telling the user where the missing item is located is merely exemplary in nature and is in no way intended to limit the invention or its applications or uses. For example, the system and method have particular application for detecting items entering a vehicle. However, as will be appreciated by those skilled in the art, the system may have application for other environments.

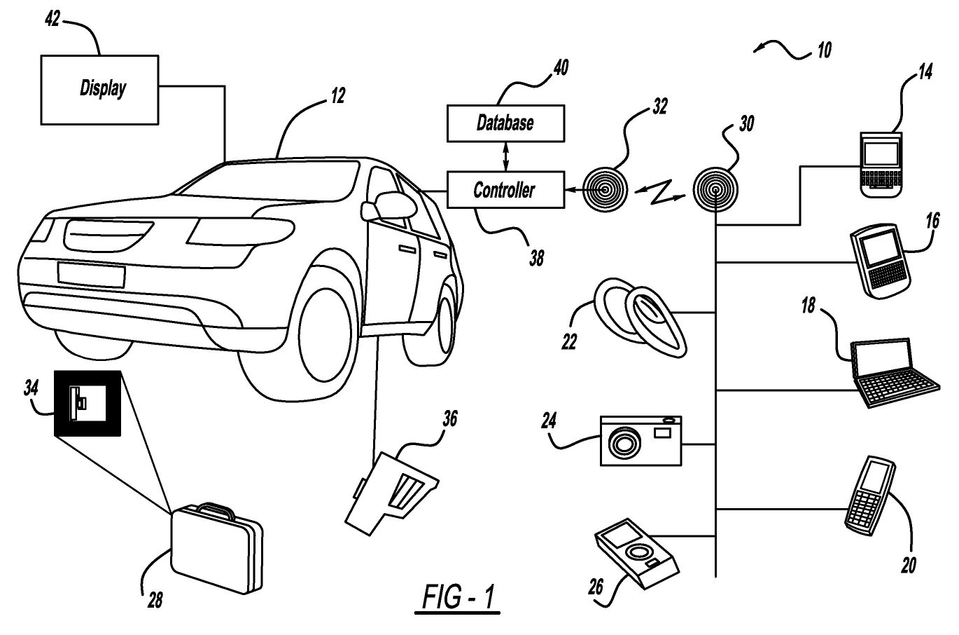

FIG. 1 is an illustration of a configuration manager system 10 that is part of a vehicle 12 and is able to detect and identify whether various electronic devices, such as a BlackBerry 14, a PDA 16, a laptop 18, a cell phone 20, an ear piece cell phone 22, a camera 24 and an MP3 player 26, and/or non-electric devices, such as a briefcase 28, are part of a particular group of items. In this non-limiting embodiment, each of the BlackBerry 14, the PDA 16, the laptop 18, the cell phone 20, the earpiece cell phone 22, the camera 24 and the MP3 player 26 have the ability to connect to the vehicle 12 by a Bluetooth communications protocol connection through an antenna 30 on the device and an antenna 32 on the vehicle 12. The antenna 30 is intended to represent a separate antenna for each of these devices.

As is well understood in the art, Bluetooth is a communications protocol that allows a device to be wirelessly connected to another device. Of course, the particular device needs to be turned on and be operating in order for the Bluetooth connection to recognize it. If the device is off, even though it may be on the person entering the vehicle 12, the system 10 may provide an indication that it is not present.

For non-electric devices or items, or other types of electronic devices, an RFID tag 34 can be placed on the device, such as the briefcase 28, and an RFID reader 36 provided on the vehicle 12 can read the RFID tag 34. An RFID tag 34 can be placed on any item that the user wishes to be recognized by the vehicle 12. The RFID reader 36 can be at any suitable location on the vehicle 12 that allows it to be close enough to read the RFID tags 34 on the devices that are brought into the vehicle 12 by the vehicle user.

According to the invention, the system 10 is able to notify the vehicle user that a particular item associated with a predetermined group of items is not among the group when the user and group of items enter the vehicle. The system 10 is controlled by a controller 38 on the vehicle 12 that includes suitable algorithms to perform the operations discussed herein. Bluetooth signals received by the antenna 32 and RFID signals detected by the RFID reader 36 are sent to the controller 38. A database 40 stores information concerning groups of items consistent with the discussion herein. For example, the controller 38 may know that the Blackberry 14, the PDA 16, the laptop 18, the cell phone 20 and the briefcase 28 are part of a “work” group. That list of items can be directly provided to the system 10 by the vehicle user as a pick list.

Alternately, the controller 38 can automatically generate groups and lists of items by recognizing that several items define a group of items or an item has been added to a group based solely on the number of times the items are carried into the vehicle 12 together. Thus, the system 10 has a pattern of use feature where the user does not need to specifically add an item to a particular group of items because the system 10 will recognize that an item is part of that group by the fact that it is continually included in the group.

When the vehicle user enters the vehicle 12, and the Bluetooth connection and/or RFID connection is made with the items carried by the user, the controller 38 will identify those items and determine whether they are part of a predetermined and stored group of items. If the controller 38 recognizes that a particular group of items has entered the vehicle 12, such as the work group, the controller 38 will then make sure all of the items that are part of the work group have entered the vehicle. If the controller 38 recognizes that an item is missing from the group, for example, the laptop 18 is missing from the work group, the controller 38 will cause a signal or warning to be sent that notifies the user that the item is missing. Such a signal can be any suitable warning signal, such as displaying the missing item on a display 42. Thus, the vehicle 12 first recognizes if a particular group is present in the vehicle 12, and if so, whether a certain item in that group is missing.

Although the discussion above refers to connections being made by the Bluetooth communications protocol and the RFID reader 36, the present invention contemplates any type of wireless communications protocol that allows the controller 38 to identify a particular item when it enters the vehicle.

Additionally, the configuration manager system 10 not only will identify that a particular item is not part of a group of items when the user enters the vehicle 12, but can also use the Bluetooth or other connection to tell the user where the item is actually located. In this embodiment, each item in the group is part of an ad-hoc internet group in which that item is located. For example, if the cell phone 20 is left in the user's house, communications from the cell phone 20 may cause it to be part of an ad-hoc network or internet group, defined below, in the house with other electronic devices that are connected to the internet as part of the network. Through an internet connection, the vehicle 12 will look for a signal identifying the cell phone 20, and be able to tell the vehicle user where that item is located.

An ad-hoc internet group as used herein is a flexible network that is formed by devices that have a communication capability, but not necessarily the ability to connect to the internet. These nomadic devices connect to an internet connected device via Bluetooth, or other, protocol joining or exiting the piconet as they enter the proximity of the internet connect device. A typical connection range is ten meters for Bluetooth IEEE 802.15.1 class 2 protocol. Since the location of the fixed location TCP/IP devices and GPS-enabled mobile TCP/IP devices are known, the location of the devices within the ad-hoc internet group is determinable with high geographic precision.

As mentioned above, the system 10 can also locate a missing item over the internet using ad-hoc internet locations by looking on the internet for a device that's been coded with the particular code of the device, and provide GPS coordinates of that location. Of course, the location where the particular device is would need to have some type of internet transmission configuration that allowed it to detect the device, and provide it in a list of devices at that location on the internet.

If the vehicle 12 is connected to the internet, the Bluetooth algorithm can be located off of the vehicle where the ad-hoc internet on the vehicle 12 would be providing the Bluetooth connection to the items.

Additionally, the configuration manager system 10 can use the Bluetooth connection to tell the state of a particular device, such as battery life, unread messages, warnings, etc. The system 10 can also tell whether a particular item has been taken by another co-owner of the item.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A configuration manager for identifying and locating a missing item, said configuration manager comprising:
a controller that is able to recognize one or more communications protocols, said controller receiving transmission signals from a plurality of items within a transmission range of the controller, said controller recognizing that at least some of the plurality of items are part of a predetermined group of items and providing a signal indicating that one of the items of the predetermined group of items is missing if the controller does not receive a transmission signal from the missing item, said controller further providing a location signal identifying the location of the missing item; and
a notifying device for notifying a user that the missing item is missing from the group of items and identifying the location of the missing item.

2. The configuration manager according to claim 1 further comprising an RFID reader, said RFID reader reading RFID tags on items that are in proximity of the reader where the RFID tagged items may be part of the predetermined group of items and where the controller will know if the RFID tagged item is missing from the group of items.

3. The configuration manager according to claim 1 wherein the predetermined group of items includes one or more of a laptop, a cell phone, a person data assistant and a briefcase.

4. The configuration manager according to claim 1 wherein the notifying device is a display.

5. The configuration manager according to claim 1 wherein one of the communications protocols is Bluetooth.

6. The configuration manager according to claim 1 wherein the controller automatically determines that a particular item is part of the predetermined group of items solely by it being with other items in the group of items a certain number of times.

7. The configuration manager according to claim 1 wherein the controller is within a vehicle.

8. The configuration manager according to claim 1 wherein the controller determines the status of operation of the items in the group of items.

9. The configuration manager according to claim 1 wherein the controller determines the location of the missing item through its connection to an ad-hoc internet group that has a known location.

10. A configuration manager for identifying and locating a missing item, said configuration manager comprising:
a controller that is able to recognize one or more communications protocols, said controller receiving transmission signals from a plurality of items within a transmission range of the controller, said controller recognizing that at least some of the plurality of items are part of a predetermined group of items and providing a signal indicating that one of the items of the predetermined group of items is missing if the controller does not receive a transmission signal from the missing item, said controller automatically determining that a particular item is part of the predetermined group of items solely by it being with other items in the group of items a certain number of times; and
a notifying device for notifying a user that the missing item is missing from the group of items.

11. The configuration manager according to claim 10 further comprising an RFID reader, said RFID reader reading RFID tags on items that are in proximity of the reader where the RFID tagged items may be part of the predetermined group of items and where the controller will know if the RFID tagged item is missing from the group of items.

12. The configuration manager according to claim 10 wherein the predetermined group of items includes one or more of a laptop, a cell phone, a person data assistant and a briefcase.

13. The configuration manager according to claim 10 wherein the notifying device is a display.

14. The configuration manager according to claim 10 wherein one of the communications protocols is Bluetooth.

15. The configuration manager according to claim 10 wherein the controller is within a vehicle.

16. The configuration manager according to claim 10 wherein the controller determines the status of operation of the items in the group of items.

17. The configuration manager according to claim 10 wherein the controller further provides a location signal identifying the location of the missing item through its connection to an ad-hoc internet group that has a known location.

18. A configuration manager for identifying and locating a missing item of a group of items that enter a vehicle, said configuration manager comprising:
a controller that is able to recognize one or more communications protocols, said controller receiving transmission signals from a plurality of items within a transmission range of the controller, said controller recognizing that at least some of the plurality of items are part of a predetermined group of items and providing a signal indicating that one of the items of the predetermined group of items is missing if the controller does not receive a transmission signal from the missing item, said controller further providing a location signal identifying the location of the missing item, said controller automatically determining that a particular item is part of the predetermined group of items solely by it being with other items in the group of items a certain number of times;
an RFID reader for reading RFID tags on items that are in proximity of the reader where the RFID tagged items may be part of the predetermined group of items and where the controller will know if the RFID tagged item is missing from the group of items; and
a notifying device for notifying a user that the missing item is missing from the group of items and identifying the location of the missing item.

19. The configuration manager according to claim 18 wherein the controller determines the status of operation of the items in the group of items.

20. The configuration manager according to claim 18 wherein the controller further provides a location signal identifying the location of the missing item through its connection to an ad-hoc internet group that has a known location.
